(19) United States
(12) Patent Application Publication
(10) Pub. No.: US 2005/0223952 A1
(43) Pub. Date: Oct. 13, 2005

(54) Hanging fryer shelf

(76) Inventors: Suzanne M. Brewer, Santa Rosa Beach, FL (US); David P. Brewer, Santa Rosa Beach, FL (US)

Correspondence Address: Richard C. Litman;LITMAN LAW OFFICES, LTD., P.O. Box 15035, Arlington, VA, 22215, US

(21) Appl. No.: 10/821,997

(22) Filed: Apr. 12, 2004

(51) Int. Cl. A47B 5/00; A47J 37/12

(52) U.S. Cl. 108/152

(57) ABSTRACT

A unitary shelf that can be supported on a commercial fryer unit. The shelf is comprised of a flat, solid, horizontal surface capable of supporting pots, pans or fry preparation food components. The shelf includes L-shaped brackets having hooked or U-shaped ends. The hooked or U-shaped ends easily fit over the edge of a commercial fryer. The shelf incorporates lips or vertical barriers on one, two or three sides thereof to prevent the pots, pans or fry preparation components from being accidentally knocked from the flat surface of the shelf.

### BACKGROUND OF THE INVENTION

1. Field of the Invention

The present invention relates to support structure. More specifically, the present invention is an auxiliary support surface adapted for removable attachment to a food fryer unit.

2. Description of the Related Art

The kitchen of a commercial eating establishment can become quite hectic during the height of the mealtime rush. At these times, efficiency is of paramount importance. Any device that contributes to increasing efficiency would be a welcome addition to the commercial kitchen environment.

In the kitchen, the area adjacent the fryer unit is usually devoid of storage space. The current invention offers a solution to this problem, which solution incorporates a device that instantly provides additional space in the form of a detachable shelf adjacent the fryer workstation. In the related art, U.S. Pat. No. 5,472,164 (Contee, Jr.) discloses a hanger adapted to be mounted to the tailgate of a truck and designed to support a portable grill thereon. The open design of the hanger would not accommodate food preparation adjuncts such as flour and/or breadcrumbs and the like.

U.S. Pat. No. 4,850,282 (Postic) is drawn to portable device including a tray surface, which surface is supported by spaced apart frame members. A pair of U-shaped members is provided to hang the frame from the railing of a balcony. The configuration of the frame members would not permit suspension from a kitchen fryer unit.

U.S. Pat. No. 4,059,248 (Kuntz), U.S. Pat. No. 4,809,941 (Sheridan), U.S. Pat. No. 4,949,924 (Carmody), U.S. Pat. No. 5,118,059 (Mainer) and U.S. Pat. No. 6,464,086 B1 (Klein et al.) disclose bracket structure for supporting shelves. The above patents do not contemplate monolithic shelf-bracket construction and require assembly.

U.S. Pat. No. 5,582,376 (Thompson) is drawn to a multiple function bracket for attaching display figures thereto. The bracket requires a slotted wall for mounting and could not be supported on a commercial fryer unit.

None of the above inventions and patents, taken either singly or in combination, is seen to disclose a unitary shelf structure detachably supported on a commercial fryer unit as will be subsequently described and claimed in the instant invention.

### SUMMARY OF THE INVENTION

The present invention is an auxiliary support surface in the form of a shelf that can be removably attached to a commercial fryer unit. The shelf is comprised of a flat, solid, horizontal surface capable of supporting pots, pans or fry preparation food components. The shelf includes L-shaped brackets having hooked or U-shaped ends. The hooked or U-shaped ends easily fit over the edge of a commercial fryer. The shelf incorporates lips or vertical barriers on one, two or three sides thereof to prevent the pots, pans or fry preparation components from being accidentally knocked from the flat surface of the shelf.

Accordingly, the present invention presents a support surface that can be easily and quickly attached to and removed from a commercial fryer unit instantly creating added workspace. The added workspace allows the fry cook to have the needed food and food constituents adjacent the fryer unit. This scenario enhances efficiency and decreases the chances for spillage, which spillage can result in dangerously slippery floors. The invention also decreases the likelihood of burn accidents in that shelf keeps the cook's body farther away from the hot frying oils. The present invention provides for improved elements and arrangements thereof for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a hanging fryer shelf according to the present invention.

FIG. 2 is a perspective view of a hanging fryer shelf according to the present invention.

FIG. 3 is a perspective view of an embodiment of a hanging fryer shelf according to the present invention.

Similar reference characters denote corresponding features consistently throughout the attached drawings.

### DETAILED DESCRIPTION OF THE PREFERRED EMBODIMENTS

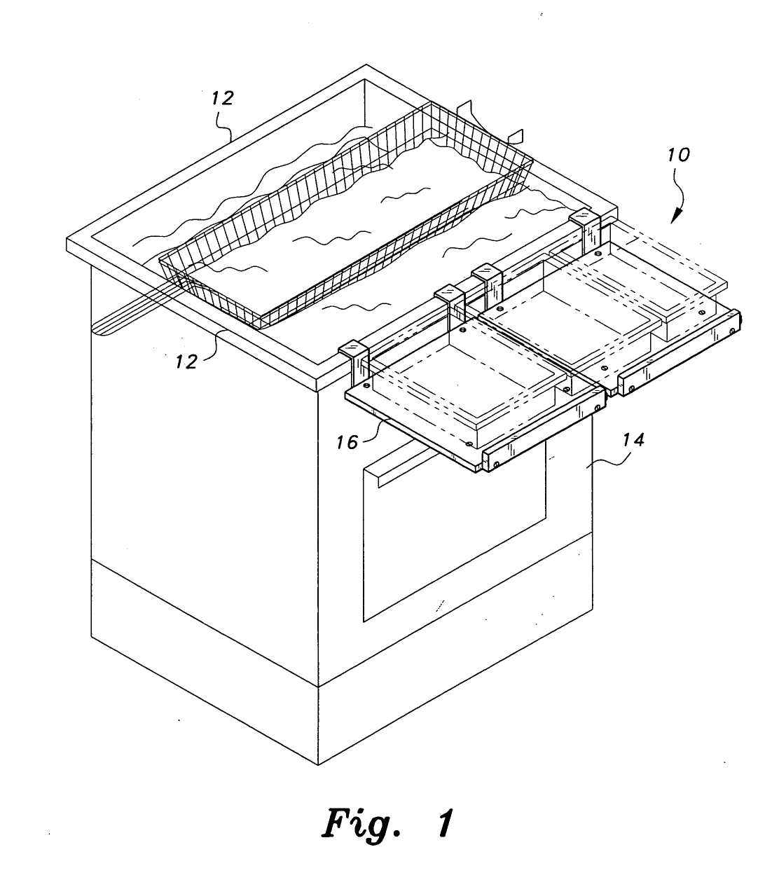

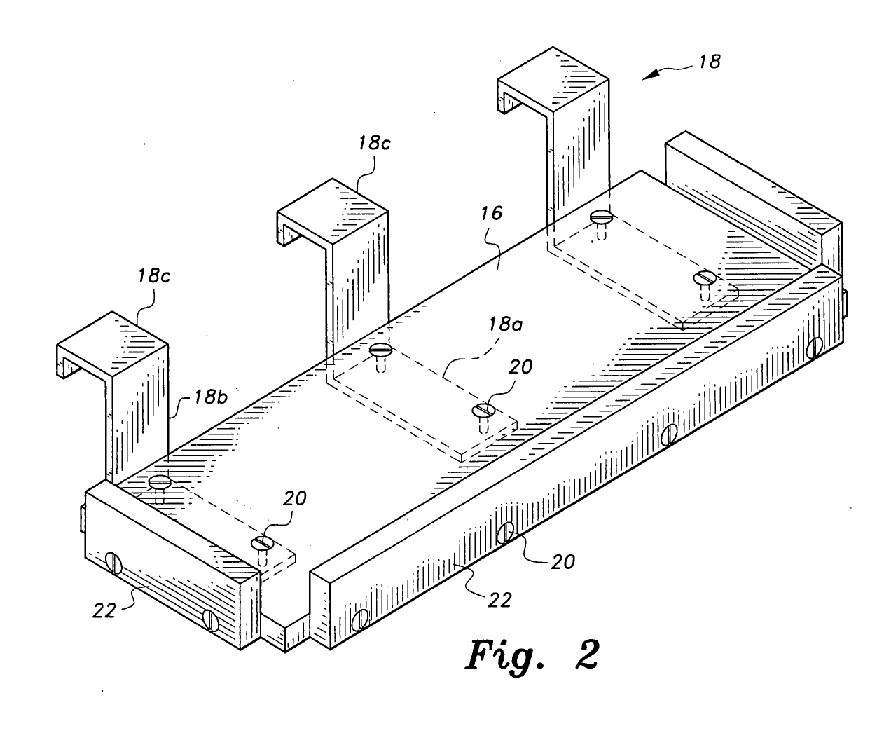

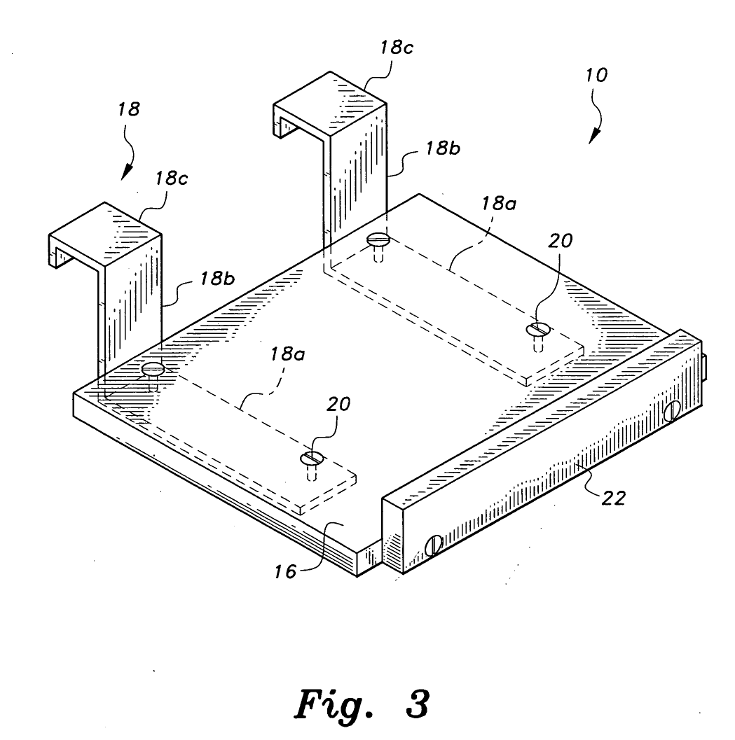

Attention is directed to FIGS. 1-3 of the drawing wherein the hanging shelf of the present invention is generally indicated at 10. Shelf 10 is adapted to be supported on the front or side edges 12 of a fryer unit 14. As illustrated in FIG. 1, two shelves are supported on the fryer unit. The shelf comprises a solid shelf surface 16 having its under face disposed on L-shaped support brackets generally indicated at 18. Although screws 20 are disclosed to attach surface 16 to brackets 18, other suitable attachment means may be employed, if desired. The top face of surface 16 is adapted to support constituents needed for frying (shown in phantom lines). Surface 16 may be fabricated in different sizes (width and length) to accommodate conventional fryer unit sizes.

Bracket 18 comprises a horizontal portion 18a and a vertical portion 18b. The vertical portion terminates in a hook portion 18c, which portion 18c fits on the edge or side 12 of the fryer unit 14 to support the self therefrom. Vertical barriers or lips 22 can be attached to the shelf surface edges on one, two or three sides to prevent the constituents from slipping off the surface. The shelf surface and brackets may be fabricated from plastic or metallic material.

It is to be understood that the present invention is not limited to the embodiments described above, but encompasses any and all embodiments within the scope of the following claims.

1. An auxiliary support surface for a fryer unit comprising:
a solid, planar shelf having an under face and a top face;
at least two L-shaped brackets, each bracket having a vertical leg and a horizontal leg, said horizontal leg engaging the under face of said shelf;
fasteners disposed through said shelf for attaching said self to said horizontal leg of each bracket; and
a hook portion disposed on each said vertical leg and defining an end of said vertical leg.

2. The auxiliary support surface for a fryer unit as recited in claim 1, wherein said fasteners are screws.

3. An auxiliary support surface for a fryer unit as recited in claim 1, wherein said shelf has three free edges and wherein a vertical barrier is attached to one of said free edges.

4. An auxiliary support surface for a fryer unit as recited in claim 1, wherein said shelf has three free edges and wherein a vertical barrier is attached to two of said free edges.

5. An auxiliary support surface for a fryer unit as recited in claim 1, wherein said shelf has three free edges and wherein a vertical barrier is attached to all of said three free edges.

6. In combination with a fryer unit, said fryer unit having at least one edge, an auxiliary support surface removably attached to said fryer unit comprising:
a solid, planar shelf having an under face and a top face;
at least two L-shaped brackets, each bracket having a vertical leg and a horizontal leg, said horizontal leg engaging the under face of said shelf;
fasteners disposed through said shelf for attaching said self to said horizontal leg of each bracket; and
a hook portion disposed on each said vertical leg and defining an end of said vertical leg, said hook portion engaging said at least one edge of said fryer unit.

7. The combination as recited in claim 6, wherein said fasteners are screws.

8. The combination as recited in claim 6, wherein said shelf has three free edges and wherein a vertical barrier is attached to one of said free edges.

9. The combination as recited in claim 6, wherein said shelf has three free edges and wherein a vertical barrier is attached to two of said free edges.

10. The combination as recited in claim 6, wherein said shelf has three free edges and wherein a vertical barrier is attached to all of said free edges.
